(19) United States
(12) Patent Application Publication
(10) Pub. No.: US 2004/0222696 A1
(43) Pub. Date: Nov. 11, 2004

(54) Vehicle brake system for preventing brake noise

(76) Inventors: Masahiko Kamiya, Anjo-city (JP); Hiroshi Kondo, Chiryu-city (JP); Shin Sasaki, Okazaki-city (JP); Daizo Oba, Kariya-city (JP)

Correspondence Address: POSZ & BETHARDS, PLC, 11250 ROGER BACON DRIVE, SUITE 10, RESTON, VA, 20190, US

(21) Appl. No.: 10/819,973

(22) Filed: Apr. 8, 2004

(30) Foreign Application Priority Data
May 9, 2003 (JP) 2003-131822

(51) Int. Cl. B60T 8/60

(52) U.S. Cl. 303/191

(57) ABSTRACT

A brake noise detecting portion detects brake noise generated in respective wheels by braking operation in a vehicle by a normal friction brake device in a vehicle running state. When the brake noise is detected in at least one of the wheels, if a brake-noise generation wheel in which the brake noise is generated is at least one of first left and right wheels, first target braking force is reduced by a first brake noise suppression variation amount, whereby it becomes new first target braking force. The new first target braking force is then applied to the first left and right wheels. If the brake-noise generation wheel is at least one of the second left and right wheels, second target braking force is reduced by a second brake noise suppression variation amount, whereby it becomes new second target braking force. The new second target braking force is applied to the second left and right wheels. Subsequently, braking force equivalent to a sum of the first and/or second brake noise suppression variation amount that are used in reduction and setting of the first and/or second target braking force is applied as the target parking braking force to the second left and right wheels by an electric parking brake.

### CROSS REFERENCE TO RELATED APPLICATION

This application is based upon and claims the benefit of Japanese Patent Application No. 2003-131822 filed on May 9, 2003, the content of which are incorporated herein by reference.

### FIELD OF THE INVENTION

The present invention relates to a vehicle brake system, and particularly to a vehicle brake system that suppresses brake noise by using a parking brake.

### RELATED ART OF THE INVENTION

According to a related art as disclosed in Japanese Patent Laid-Open Publication No. 10-329681, a brake system that is provided with both a regenerative brake and a friction brake is proposed. This system controls, when brake noise is detected, a braking force ratio of the regenerative brake and the friction brake while maintaining the total braking force of a wheel with which the brake noise has occurred, such that the set braking force can avoid being in a brake noise generation area.

According to the related art, brake noise suppression and the total braking force of the wheel are assured for an electric vehicle and hybrid vehicle having a regenerative brake. However, it was difficult for a vehicle that does not have the regenerative brake and only has a friction brake, such as for a vehicle employing a general internal combustion engine, to achieve both objectives.

### SUMMARY OF THE INVENTION

It is an object of the present invention to suppress brake noise while maintaining a total braking force of left and right wheels of a vehicle, respectively, by the use of a friction brake.

In a first aspect of the present invention, a brake noise detecting portion detects brake noise generated in respective wheels due to braking operation of a vehicle in a vehicle running state by a normal friction brake device. When the brake noise is detected in at least one of the wheels, if a brake-noise generation wheel in which the brake noise is detected is at least one of the first left and right wheels, a first target braking force is reduced by a first brake noise suppression variation amount, whereby it will become new first target braking force. The new first target braking force is then applied to the first left and right wheels. Furthermore, if the brake-noise generation wheel is at least one of second left and right wheels, a second target braking force is reduced by a second brake noise suppression variation amount, whereby it will become new second target braking force. The new second target braking force is then applied to the second left and right wheels. In this case, target braking force of left and right wheels with no brake noise generation is not changed. On the other hand, an electric parking brake applies, to the second left and right wheels, braking force, as target parking braking force, which is equivalent to a sum of the first and/or second brake noise suppression variation amount used in reduction and setting of the first and/or second target braking force.

As is generally known, the brake noise is likely to be generated when the braking force by a friction brake is in a specific range (brake noise generation area). By reducing (or increasing) the braking force by the friction brake by a certain amount so as to avoid the braking force from being in the brake noise generation area, the brake noise can be reduced and suppressed, or further be prevented.

Therefore, according to the first aspect of the present invention, the braking force, by the normal friction brake device, of the brake-noise generation wheel is reduced and changed by the first and/or second brake noise suppression variation amount, so as to avoid the braking force from being in the brake noise generation area. Accordingly, a vibration state is changed to reduce and suppress the brake noise, and the electric parking brake applies to the second left and right wheels the braking force equivalent to the amount of reduction of the braking force by the normal friction brake device. As a result, the total braking force of the vehicle is made constant and a change in the braking force on the left and right sides can be eliminated. Consequently, the braking force intended by a driver can be ensured without involving occurrence of abnormal vehicle behavior during execution of brake control for suppressing the brake noise. Therefore, an unpleasant sensation is not given to the driver.

In a preferred form of the first aspect of the invention, when the brake noise is detected in the second left and right wheels, the braking force by the normal friction brake device for the second left and right wheels is reduced by the second brake noise suppression variation amount to reduce and suppress the brake noise. Also, the electric parking brake applies the target parking braking force by the amount equivalent to the reduced second brake noise suppression variation amount. Accordingly, the braking force of the second left and right wheels can be made constant, respectively, and the braking force intended by the driver can be ensured without involving occurrence of abnormal vehicle behavior.

In another preferred form of the first aspect of the invention, when the brake noise is generated in at least one of the first left and right wheels which are not provided with the electric parking brake, the first left and right wheels are applied with the first target braking force with the first brake noise suppression variation amount reduced therefrom, thereby reducing and suppressing the brake noise. At the same time, the target parking braking force equivalent to the first brake noise suppression variation amount is applied to the second left and right wheels. Consequently, the total braking force of the first and second left and right wheels in the front and rear can be made constant, whereby the braking force intended by the driver can be ensured and occurrence of abnormal vehicle behavior can be prevented.

In still another preferred form of the first aspect of the invention, when the brake noise is generated in all of the first and second left and right wheels, namely, the left and right front wheels and the left and right rear wheels, the first and second brake noise suppression variation amounts are reduced from the first and second target braking force, respectively, and the braking force is applied to respective wheels by the normal friction brake device to reduce and suppress the brake noise. Furthermore, the electric parking brake applies the target parking braking force, to the second left and right wheels, as the braking force equivalent to a sum of the first and second brake noise suppression variation amounts that is equivalent to the aforementioned braking force reduction amount. Accordingly, the total braking force of the first and second left and right wheels in the front and rear of the vehicle can be made constant, whereby the braking force intended by the driver can be ensured and occurrence of abnormal vehicle behavior can be prevented.

In a second aspect of the present invention, when the brake noise is generated in the second left and right wheels of either one of the left and right front wheels or the left and right rear wheels, a control portion operates the electric parking brake and applies the target parking braking force of a predetermined value to the second left and right wheels. As a result, in addition to the second target braking force by the normal friction brake device, the target parking braking force by the electric parking brake is applied to the second left and right wheels, respectively. Accordingly, restriction force is applied to a brake rotor from two points, thereby changing the vibration mode, which as a result allows reduction and suppression of the brake noise. Moreover, the electric parking brake generates the same amount of braking force to each of the second left and right wheels. Therefore, vehicle behavior in a horizontal direction does not change, thus giving no unpleasant sensation to the driver.

It should be noted that the target parking braking force is a fluctuating value with a constant frequency. Accordingly, the braking force that changes at a constant frequency is applied to the electric parking brake, thereby suppressing the brake noise. Even if such a change in the braking force is minute, the brake noise generation area can be avoided.

Furthermore, by setting the target parking braking force to a fluctuating value that has the equivalent frequency but has an opposite phase to vibration of the brake noise detected, the electric parking brake can generate vibration that directly eliminates the vibration of the brake noise.

### BRIEF DESCRIPTION OF THE DRAWINGS

Other objects, features and advantages of the present invention will be understood more fully from the following detailed description made with reference to the accompanying drawings. In the drawings:

FIG. 1 is a diagram illustrating a schematic construction of a vehicle brake system according to an embodiment of the present invention;

FIG. 2 is a flowchart illustrating a main routine of brake control according to the embodiment;

FIG. 3 is a flowchart illustrating a procedure of brake noise prevention brake control processing according to the embodiment;

FIGS. 4A, 4B, and 4C are figures illustrating, respectively, set conditions of a variation amount of target braking force for each wheel in the brake noise prevention brake control; and

FIG. 5 is a flowchart illustrating a procedure of brake noise prevention brake control processing according to modifications.

### DETAILED DESCRIPTION OF THE PREFERRED EMBODIMENTS

The present invention will be described further with reference to various embodiments in the drawings.

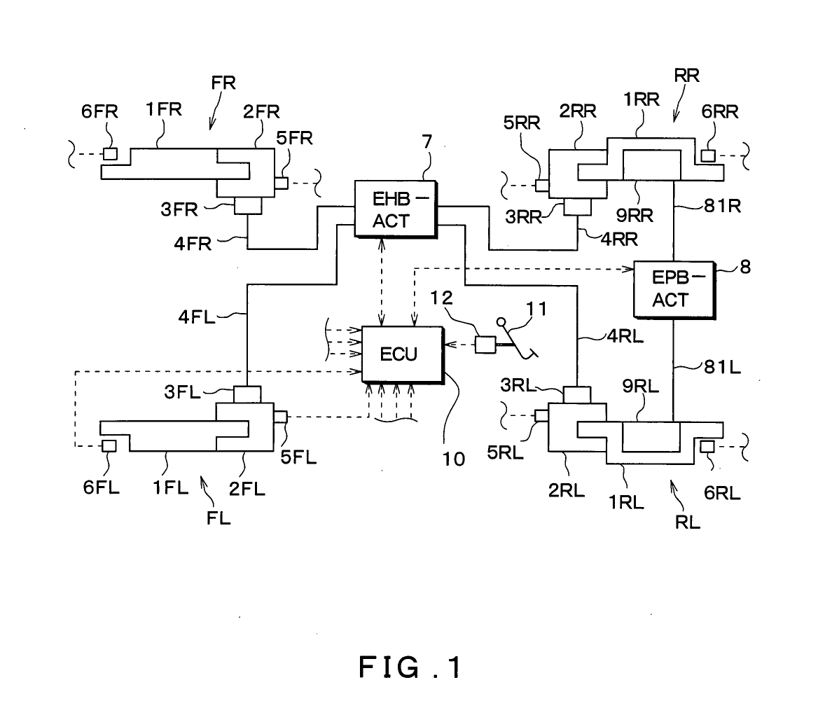

A vehicle brake system according to an embodiment of the present invention will be described with reference to the attached drawings. FIG. 1 is a diagram illustrating a schematic construction according to the present embodiment. In this embodiment, a left front wheel is referred to as FL, a right front wheel as FR, a left rear wheel as RL, and right rear wheel as RR, respectively.

The left and right front wheels FL and FR which are first left and right wheels are respectively provided with front wheel disc rotors 1FL and 1FR that rotate together with the wheels; calipers 2FL and 2FR that support pads (not shown) provided at both ends of the front wheel disc rotors 1FL and 1FR; cylinders 3FL and 3FR that drive the pads; and wheel speed sensors 6FL and 6FR that detect rotational speeds of the front wheel disc rotors 1FL and 1FR. Furthermore, the calipers 2FL and 2FR are attached with vibration sensors 5FL and 5FR, respectively. The vibration sensors 5FL and 5FR detect vibration generated in the calipers 2FL and 2FR.

As with the left and right front wheels FL and FR, the left and right rear wheels RL and RR which are second left and right wheels are respectively provided with rear wheel disc rotors 1RL and 1RR; calipers 2RL and 2RR that support pads (not shown) provided at both ends of the rear wheel disc rotors 1RL and 1RR; cylinders 3RL and 3RR that drive the pads; and wheel speed sensors 6RL and 6RR that detect rotational speeds of the rear wheel disc rotors 1RL and 1RR. Furthermore, the calipers 2RL and 2RR are attached with vibration sensors 5RL and 5RR, respectively. The vibration sensors 5RL and 5RR detect vibration generated in the calipers 2RL and 2RR.

It should be noted that the left and right rear wheels RL and RR which are the second left and right wheels have, inside the rear wheel disc rotors 1RL and 1RR, drum brakes 9RL and 9RR, respectively, which are so-called drum-in-disc brakes and which function as parking brakes.

According to the present embodiment, the vehicle brake system is provided with an electro-hydraulic brake (hereinafter referred to as “EHB-ACT”) 7, an electric parking brake (hereinafter referred to as “EPB-ACT”) 8, and a brake control device (hereinafter referred to as “ECU”) 10.

The EHB-ACT 7 is a normal friction brake device of the present invention. The EHB-ACT 7 adjusts brake fluid pressure that is accumulated by a pump (not shown) and an accumulator (not shown), by controlling linear valves disposed in respective brake fluid conduits of each channel so as to obtain the brake fluid pressure corresponding to target braking force of each wheel that is set by the ECU 10 description of which is provided below. Then, the brake fluid pressure adjusted is applied to each of the cylinders 3FL, 3FR, 3RL, and 3RR of the respective wheels via brake fluid conduits 4FL, 4FR, 4RL, and 4RR connected to the corresponding cylinders, whereby the target braking force set for each wheel is generated.

The EPB-ACT 8 pulls cables 81L and 81R connected to the drum brakes 9RL and 9RR, by an electric motor (not shown). In this case, the electric motor is operated with the rotational amount and at the rotational speed corresponding to target parking braking force as the target braking force for the EPB-ACT 8 that is set by the ECU 10. As a result, an equal amount of target parking braking force is generated in the drum brakes 9RL and 9RR, respectively.

The ECU 10 is supplied with a detection signal from a stroke sensor 12 that detects the amount of depression of a brake pedal 11. In addition, via respective wheels FL, FR, RL, and RR, the ECU 10 is supplied with detection signals obtained from the vibration sensors 5FL, 5FR, 5RL, and 5RR and the wheel speed sensors 6FL, 6FR, 6RL, and 6RR. In the ECU 10, a brake noise detection signal which is a signal in a frequency band (for example, several 100 Hz or 10 kHz) corresponding to the brake noise is extracted from the detection signals from the vibration sensors 5FL, 5FR, 5RL, and 5RR. That is, the ECU 10 and the vibration sensors 5FL, 5FR, 5RL, and 5RR correspond to a brake noise detecting portion of the present invention.

The ECU 10 calculates and sets individually a target value of the braking force to be applied to respective wheels so as to decelerate or stop a vehicle based on respective sensor signals. In other words, for example, in a running state or a braking state during turning where a coefficient of friction of a road surface differs in the left and right sides of the vehicle, different target braking force is applied to the left and right wheels, respectively, whereby braking is applied to the vehicle without involving an occurrence of abnormal vehicle behavior.

It should be noted that herebelow, with regard to the target value for the EHB-ACT 7, the target braking force applied to the left and right front wheels FL and FR, respectively, are collectively referred to as first target braking force, and the target braking force applied to the left and right rear wheels RL and RR, respectively, are collectively referred to as second target braking force. In the following description, unless otherwise specified particularly, the same amounts of the first and second target braking force are applied to the left and right front wheels and the left and right rear wheels, respectively.

As in the aforementioned manner, the ECU 10 operates the EHB-ACT 7 on the basis of the first and second target braking force calculated, or operates the EPB-ACT 8 on the basis of the target parking braking force calculated, so as to generate a target braking force for the respective wheels FL, FR, RL, and RR. Furthermore, the left and right rear wheels RL and RR which are the second left and right wheels are applied with two types of braking force separately, that is, the second target braking force from the normal friction brake device and the target parking braking force due to the electric parking brake.

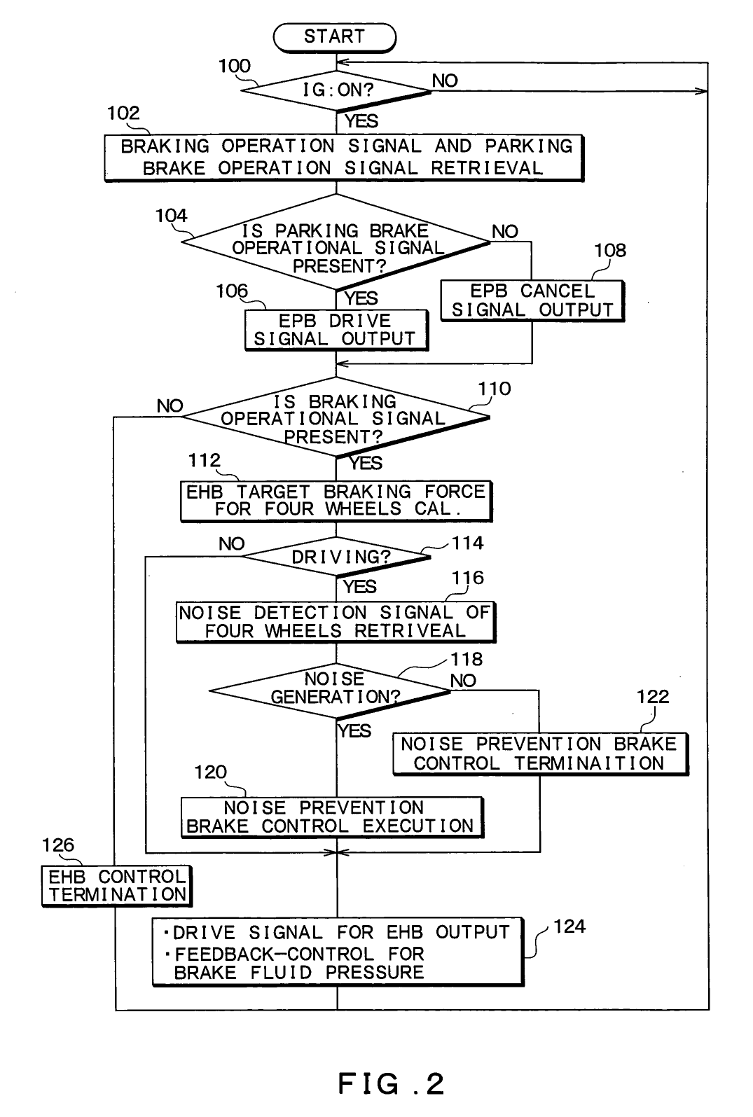

Next, a description is given of a procedure of the brake control processing executed by the ECU 10. FIG. 2 is a flowchart illustrating a main routine of the brake control. The main routine is caused to start by operation of turning on an ignition switch at 100. Then, the procedure proceeds to processing at 102 to retrieve an operation signal for the EHB-ACT 7 and EPB-ACT 8, which represents an operational state. A detection signal from the stroke sensor 12 is employed as a braking operation signal for the EHB-ACT 7, while a switch signal obtained from a parking brake lever (not shown), a parking brake operation switch (not shown), and the like is employed as an operation signal (parking brake operation signal) for the EPB-ACT 8.

At 104, if the parking brake operation signal is present, an EPB drive signal is output to operate the EPB-ACT 8 at 106. If the parking brake operation signal is not present, an EPB cancel signal is output to cancel the operation of the EPB-ACT 8 at 108 of the procedure.

Next, presence of the brake operation signal is determined at 110 of the procedure. If the brake operation signal is not present, the procedure proceeds to processing at 126 to terminate the operation of the EHB-ACT 7. If the brake operation signal is present, the procedure proceeds to processing at 112.

At 112, the first and second target braking force Ff and Fr which are the target braking force for the four wheels are calculated based on sensor signals from the stroke sensor 12 and the wheel speed sensors 6FL to 6RR of respective wheels. In the next processing at 114, determination is made as to whether a vehicle is in a running state or a stop state based on the sensor signals from the wheel speed sensors 6FL to 6RR. If the vehicle is in the stop state, the procedure proceeds to processing at 124. On the other hand, if the vehicle is in the running state, the procedure proceeds to processing at 116.

At 116, a brake noise detection signal based on the sensor signals from the vibration sensors 5FL to 5RR of the four wheels is retrieved, and, based on the noise detection signal, determination is made as to whether brake noise has been generated in any one of the four wheels at 118 of the procedure. If the determination result is YES, the procedure proceeds to processing at 120 to execute brake noise prevention brake control to suppress the brake noise. If the result is NO, that means the brake noise is not generated (is suppressed). Therefore, the procedure proceeds to processing at 122 to terminate the brake noise prevention brake control.

At 124, drive signals for the EHB-ACT 7 according to the first and second target braking force that have been set are output, and the brake fluid pressure in respective brake fluid conduits 4FL to 4RR of each channel of EHB-ACT 7 is feedback-controlled so as to match the respective pressure values to the target values.

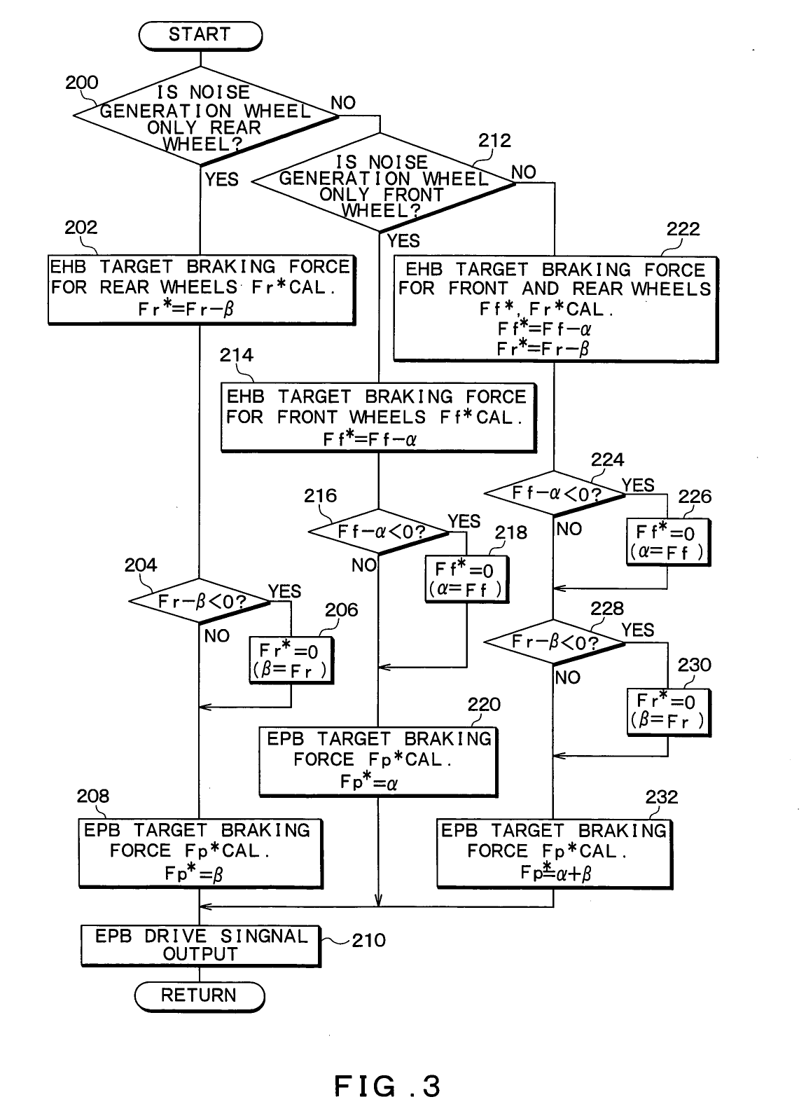

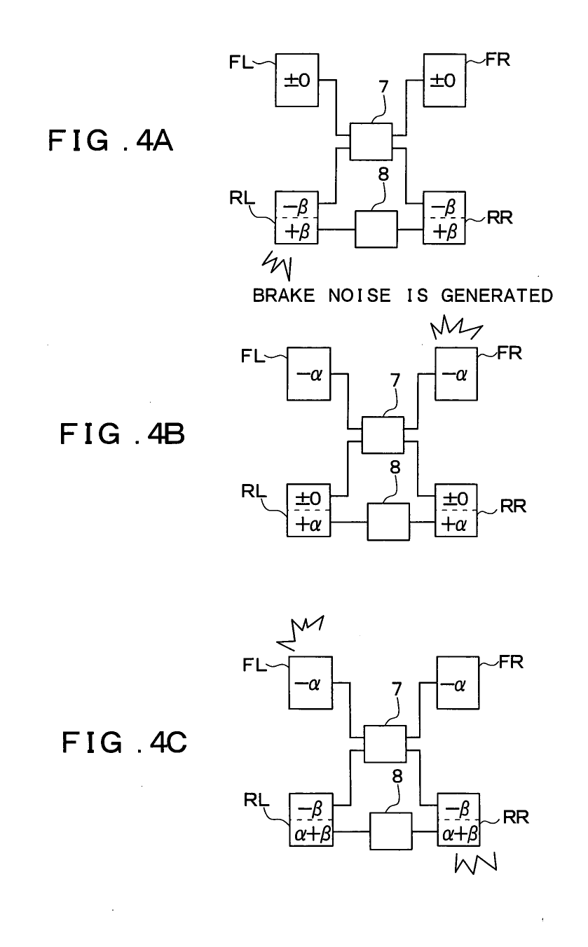

Next, a procedure of the brake noise prevention brake control processing executed at 120 is described with reference to a flowchart of FIG. 3. In addition, conditions of the target braking force for respective wheels that are set as a result of the brake noise prevention brake control will be described based on FIGS. 4A, 4B, and 4C.

At 200 of the procedure, based on the retrieved brake noise detection signals of the respective wheels, determination is made as to whether a wheel in which the brake noise is generated (a brake-noise generation wheel) is only a rear wheel which is the second left and right wheels, namely, it is determined whether the brake noise is generated in at least one of the left and right rear wheels RL and RR. If the result is YES, the procedure proceeds to processing at 202, and if the result is NO, the procedure proceeds to processing at 212.

At 202, second target braking force Fr* as the EHB target braking force of the left and right rear wheels RL and RR which are the second left and right wheels, is calculated by equation 1 by using the original second target braking force Fr that is set prior to the execution of the brake noise prevention brake control and a second brake noise suppression variation amount β.

Fr*=Fr−β [Equation 1]

In the above equation, the second brake noise suppression variation amount β is braking force necessary for avoiding being in a brake noise generation area of the left and right rear wheels RL and RR. The value of the second brake noise suppression variation amount β is preset. Namely, by reducing the braking force corresponding to the second brake noise suppression variation amount β from the second target braking force Fr in the EHB-ACT 7 which is the normal friction brake device, the brake noise generation area of the second left and right wheels can be avoided.

Next, determination is made as to whether the calculated second target braking force Fr* assumes a negative value or not. If the result is YES, setting is changed to Fr*=0, that is, β=Fr at 206 of the procedure because the negative braking force cannot be generated. If the result is NO, the procedure proceeds to processing at 208.

At 208, an EPB target braking force Fp* as the target parking braking force of the left and right rear wheels RL and RR is calculated based on equation 2. In other words, the target parking braking force Fp* is set to the second brake noise suppression variation amount β.

Fp*=β [Equation 2]

The amount of variation in the target braking force for each wheel set by processing from 202 to 208 above will be as shown in FIG. 4A. FIGS. 4A to 4C illustrate the variation amount with respect to the original target braking force that is set prior to execution of the brake noise prevention brake control for each wheel.

In this case, if the brake noise is generated in at least one of the left and right rear wheels FR and RR which are the second left and right wheels on which the braking force by the EPB-ACT 8 can be caused to act, the braking force corresponding to the second brake noise suppression variation amount β is reduced from the second target braking force which is the braking force by the EHB-ACT 7 for the second left and right wheels, thereby avoiding brake noise generation. At the same time, the target parking braking force which is the braking force corresponding to the reduced amount β is applied to the second left and right wheels by the EPB-ACT 8. Furthermore, the first target braking force which is the braking force of the first left and right wheels in which the brake noise is not generated is not changed.

Therefore, the braking force for the second left and right wheels can be made constant, respectively. That is, the total braking force in each of the left and right sides of the vehicle can be made constant, and the total braking force for all four wheels can also be made constant. Accordingly, no abnormality is generated in the vehicle behavior.

After setting respective target braking force as described above, a drive signal is output to the EPB-ACT 8 based on the target parking braking force Fp* at 210 of the procedure. Based on the drive signal, the EPB-ACT 8 generates the target parking braking force Fp* in the left and right rear wheels RL and RR.

If the determination result is NO at 200 of the procedure, the procedure proceeds to processing at 212. At 212, determination is made as to whether the brake noise is generated only in the front wheels which are the first left and right wheels, that is, only in the left and right front wheels FL and FR. If the result is YES, the brake noise is generated in at least one of the left and right front wheels FL and FR, and no brake noise is generated in any of the left and right rear wheels RL and RR. Accordingly, the procedure proceeds to processing at 214. On the other hand, if the result is NO, the procedure proceeds to processing at 222.

At 214, the first target braking force Ff* as the EHB target braking force of the left and right front wheels FL and FR which are the first left and right wheels, is calculated by equation 3 by using the original first target braking force Ff that is set prior to execution of the brake noise prevention brake control and a first brake noise suppression variation amount α.

Ff*=Ff−α [Equation 3]

In the above equation, the first brake noise suppression variation amount α is braking force necessary to avoid being in the brake noise generation area of the left and right front wheels FL and FR. The first brake noise suppression variation amount α is preset. Namely, by reducing the braking force corresponding to the first brake noise suppression variation amount α from the first target braking force Ff in the normal friction brake device, the brake noise generation area of the first left and right wheels can be avoided.

The first and second brake noise suppression variation amounts α and β are set, respectively, in consideration of weight distribution between the front and rear of the vehicle, appropriate braking force distribution, and vibration characteristics of each brake caliper and rotor, and normally assume different values with each other.

Then at 216 of the procedure, determination is made as to whether the calculated first target braking force Ff* assumes a negative value or not. If the result is YES, the setting is changed to Ff*=0, namely, α=Ff at 218 of the procedure, because negative braking force cannot be generated. If the result is NO, the procedure proceeds to processing at 220.

At 220, an EPB target braking force Fp* as the target parking braking force of the left and right rear wheels RL and RR which are the second left and right wheels is calculated based on equation 4. That is, the target parking braking force Fp* is set to the first brake noise suppression variation amount α. Then, the procedure proceeds to processing at 210.

Fp*=α [Equation 4]

The amount of variation in the target braking force for each wheel set by processing from 214 to 220 above will be as shown in FIG. 4B.

In this case, when the brake noise is generated in at least one of the left and right front wheels FL and FR which are the first left and right wheels on which the braking force by the EPB-ACT 8 as the electric parking brake does not act, the brake noise is avoided by reducing the braking force corresponding to the first brake noise suppression variation amount a from the first target braking force which is the braking force by the EHB-ACT 7, as the normal friction brake device, in the first left and right wheels. At the same time, the target parking braking force which is the braking force corresponding to the reduced amount α is caused to act on the second left and right wheels by the EPB-ACT 8. It should be noted that the second target braking force which is the braking force by the EHB-ACT 7 in the second left and right wheels is not changed.

Therefore, the total braking force in each of the left and right sides of the vehicle can be made constant, and the total braking force for all four wheels can also be made constant. Accordingly, no abnormality is generated in the vehicle behavior.

If the determination result at 212 is NO, the brake noise is generated in at least one of the wheels of the left and right front wheels FL and FR which are the first left and right wheels, and also at least one of the left and right rear wheels RL and RR which are the second left and right wheels. Hence, at 222 of the procedure, the first and second target braking force Ff* and Fr* which are the EHB target braking force of the front and rear wheels are calculated by the aforementioned equation 3 and 1, respectively.

A processing in a case where the first target braking force Ff* calculated is a negative value is executed at 224 and 226 of the procedure, in similar way as at 216 and 218. Furthermore, processing in a case in which the second target braking force Fr* calculated is a negative value is executed at 228 and 230 of the procedure, in similar way as at 204 and 206.

Then, at 232 of the procedure, the EPB target braking force Fp* as the target parking braking force of the left and right rear wheels RL and RR which are the second left and right wheels is calculated based on equation 5. That is, the target parking braking force Fp* is set as a sum of the first brake noise suppression variation amount α and the second brake noise suppression variation amount β. Subsequently, the procedure proceeds to processing at 210.

Fp*=α+β [Equation 5]

The amount of variation in the target braking force of each wheel set by the aforementioned processing at 222 and 232 will be as shown in FIG. 4C.

In this case, with regard to the brake noise generated in at least one of the left and right front wheels FL and FR which are the first left and right wheels on which the braking force by the EPB-ACT 8 which is the electric parking brake does not act, the braking force corresponding to the first brake noise suppression variation amount α is reduced from the first target braking force which is the braking force by the EHB-ACT 7 as the normal friction brake device, in the first left and right wheels, thereby avoiding the brake noise. Furthermore, with regard to the brake noise generated in at least one of the left and right rear wheels FR and RR which are the second left and right wheels on which the braking force by the EPB-ACT 8 can be caused to act, the braking force corresponding to the second brake noise suppression variation amount β is reduced from the second target braking force which is the braking force by the EHB-ACT 7 in the second left and right wheels, thereby avoiding brake noise. At the same time, the target parking braking force which is the braking force corresponding to the reduced amount α+β is caused to act on the second left and right wheels by the EPB-ACT 8.

Consequently, the total braking force in each of the left and right sides of the vehicle can be made constant, and the total braking force in all four wheels can be made constant. As a result, abnormality is not generated in the vehicle behavior.

(Modifications)

In the aforementioned embodiment, the normal friction brake device and the electric parking brake are used in combination depending on conditions of brake noise generation in each wheel, so as to reduce the target braking force by the normal friction brake device, and to increase the target parking braking force of the electric parking brake by the amount of reduction in the target braking force by the normal friction brake device. However, control of the normal friction brake device may be unnecessarily for reducing and suppressing the brake noise.

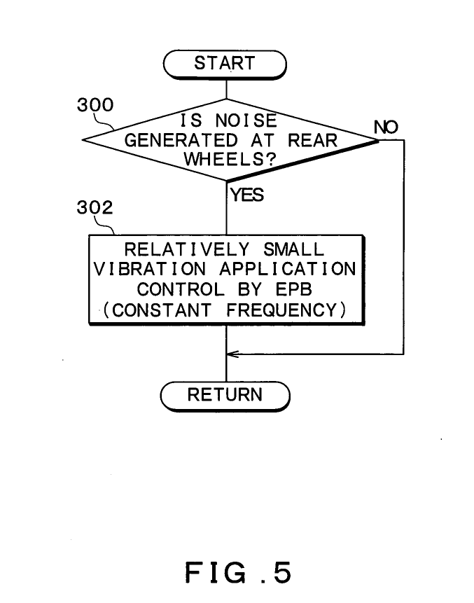

That is, according to this modification, the brake noise prevention brake control executed at 120 (FIG. 2) may be carried out as shown in a flowchart shown in FIG. 5 in place of that shown in FIG. 3. At 300 of the procedure, determination is made as to whether a wheel with brake noise is at least one of the left and right rear wheels RL and RR, on the basis of a retrieved brake noise detection signal of each wheel. If the result is NO, this routine is terminated. If the result is YES, the procedure proceeds to processing at 302.

At 302, vibration application control is executed only on the left and right rear wheels RL and RR which are the second left and right wheels by the EPB-ACT 8. The vibration application control applies braking force that varies minutely at a constant frequency as the target parking braking force. It should be noted that the vibration application control is executed by rotating the electric motor included in the EPB-ACT 8 forward or in reverse.

As described above, if the braking force applied to the EPB-ACT 8 is assumed to be the amount of variation with a constant frequency, even if the amount of variation is relatively small, the vibration mode of the brake noise can be changed to avoid the brake noise. Accordingly, a time averaged value of the braking force that is controlled by the vibration application control can be made as close as to zero. As a result, the total braking force in each of the left and right sides of the vehicle as well as that of the all four wheels can both be made substantially constant, without reducing (changing) the braking force applied to other wheels by the normal friction brake device.

Moreover, the vibration application control at 302 of the procedure according to another embodiment above may be executed by applying vibration, as the target parking braking force, at the equivalent frequency of the brake noise, instead of a constant frequency, and in the opposite phase (phase difference=180 degrees) to the phase of the brake noise. The vibration application control in this case can be achieved by the ECU 10 extracting a frequency and a phase of vibration caused by the brake noise on the basis of the detection signals from the vibration sensors 5RL and 5RR, and outputting a drive signal for the EPB-ACT 8 according to the extracted frequency and phase. Accordingly, vibration caused by the brake noise can be directly eliminated even with a minute variation amount of the braking force, thus enhancing effects of brake noise reduction and suppression.

In each of the aforementioned embodiments, the normal friction brake device applies the first target braking force, by an equal amount, to each of the left and right front wheels, and the second target braking, by an equal amount, to each of the left and right rear wheels. However, in addition to such a case, a different target braking force can be applied to each of the left and right wheels for both front and rear. In other words, even if braking force is applied individually to each of the four wheels, the total braking force on each of the left and right sides of the vehicle as well as that of all four wheels can be made constant, by executing the brake noise prevention brake control that applies the same target parking braking force to the second left and right wheels, and that reduces, by the same amount on left and right wheels, the braking force corresponding to the aforementioned target parking braking force from the first target braking force and/or the second target braking force.

The aforementioned embodiments described examples in which the electro-hydraulic brake (EHB) is used as the normal friction brake device. In addition to such examples, however, an electro-mechanical brake (EMB) that pressurizes a friction member by an electric motor and a direct-acting converting mechanism provided for each wheel may alternatively be used. By using the electro-mechanical brake and the electric parking brake (EPB) in combination, the similar effects that were achieved in each of the aforementioned embodiments can be obtained.

Moreover, in the respective embodiments above, the left and right rear wheels RL and RR are the second left and right wheels to which braking force is applied by the electric parking brake. However, in addition to such examples, the left and right front wheels FL and FR may alternatively be the second left and right wheels.

While the above description is of the preferred embodiments of the present invention, it should be appreciated that the invention may be modified, altered, or varied without deviating from the scope and fair meaning of the following claims.

What is claimed is:

1. A vehicle brake system provided in a vehicle in which a normal friction brake device is operated according to first and second target force, respectively, whereby braking is applied to first left and right wheels, which are either one of left and right front wheels and left and right rear wheels, and second left and right wheels, which are the other one of the left and right front wheels (FL, FR) and the left and right rear wheels, comprising:
a brake noise detecting portion that detects brake noise in respective wheels of the vehicle;
an electric parking brake that applies, to the second left and right wheels, braking force according to target parking braking force set separately from the second target braking force; and
a control portion that, when brake noise is detected in at least one of the respective wheels by the brake noise detecting portion, reduces a first brake noise suppression variation amount from the first target braking force to set new first target braking force in a case in which the first left and right wheels include a brake-noise generation wheel which is a wheel in which the brake noise is detected; reduces a second brake noise suppression variation amount from the second target braking force to set new second target braking force in a case in which the second left and right wheels include the brake-noise generation wheel; sets the target parking braking force to braking force equivalent to a sum of the first and second brake noise suppression variation amounts used in the reduction calculation; operates the normal friction brake device according to the new first and second target braking force; and operates the electric parking brake according to the set target parking braking force.

2. The vehicle brake system according to claim 1, wherein, when brake noise is detected only in at least one of the second left and right wheels by the brake noise detecting portion, the control portion reduces the second target braking force by the second brake noise suppression variation amount to set new second target braking force, and sets the target parking braking force to braking force equivalent to the second brake noise suppression variation amount.

3. The vehicle brake system according to claim 1,
wherein, when brake noise is detected only in at least one of the first left and right wheels by the brake noise detecting portion, the control portion reduces the first target braking force by the first brake noise suppression variation amount to set new first target braking force, and sets the target parking braking force to braking force equivalent to the first brake noise suppression variation amount.

4. The vehicle brake system according to claim 1, wherein, when brake noise is detected both in at least one of the first left and right wheels and in at least one of the second left and right wheels by the brake noise detecting portion, the control portion reduces the first and second target braking force by the first and second brake noise suppression variation amounts, respectively, to set new first and second target braking force, and sets the target parking braking force to braking force equivalent to a sum of the first and second brake noise suppression variation amounts that have been reduced.

5. A vehicle brake system provided in a vehicle in which a normal friction brake device is operated according to first and second target force, respectively, whereby braking is applied to first left and right wheels, which are either one of left and right front wheels and left and right rear wheels, and second left and right wheels, which are the other one of the left and right front wheels (FL, FR) and the left and right rear wheels, comprising:
a brake noise detecting portion that detects brake noise in respective wheels of the vehicle;
an electric parking brake that applies, to the second left and right wheels, braking force according to target parking braking force set separately from the second target braking force; and
a control portion that, when brake noise is detected in at least one of the second left and right wheels by the brake noise detecting portion, sets the target parking braking force to a predetermined value, operates the normal friction brake device according to the first and second target braking force, and operates the electric parking brake according to the set target parking braking force.

6. The vehicle brake system according to claim 5, wherein the target parking braking force is a fluctuating value with a constant frequency.

7. The vehicle brake system according to claim 5, wherein the target parking braking force is a fluctuating value with a frequency equivalent to and of an opposite phase to vibration of the detected brake noise.
